(19) United States
(12) Patent Application Publication
(10) Pub. No.: US 2026/0063952 A1
(43) Pub. Date: Mar. 5, 2026

(54) LIQUID CRYSTAL DISPLAY DEVICE

(71) Applicants: Sharp Display Technology Corporation, Kameyama City (JP); Sharp Kabushiki Kaisha, Sakai City (JP)

(72) Inventors: Yasuyoshi KAISE, Kameyama City (JP); Tomoo FURUKAWA, Sakai City (JP)

(21) Appl. No.: 19/311,384

(22) Filed: Aug. 27, 2025

(30) Foreign Application Priority Data
Aug. 30, 2024 (JP) 2024-150156

(51) Int. Cl. G02F 1/1343; G02F 1/1333; G02F 1/1335; G02F 1/1362

(52) U.S. Cl. CPC G02F 1/134309; G02F 1/133345; G02F 1/133514; G02F 1/136213

(57) ABSTRACT

A liquid crystal display device comprises a liquid crystal layer; a pixel electrode and a common electrode both provided below the liquid crystal layer to form a liquid crystal capacitor; an organic layer formed in an underlying layer of the pixel electrode and the common electrode; a relay electrode formed in an underlying layer of the organic layer and connected electrically to the pixel electrode; and a capacitor electrode formed in an underlying layer of the organic layer to form a retention capacitor between the capacitor electrode and the relay electrode.

### FIELD OF THE INVENTION

The present disclosure relates to liquid crystal display devices.

### BACKGROUND OF THE INVENTION

Japanese Unexamined Patent Application Publication No. 2009-58913 discloses a technique to increase retention capacitance in a liquid crystal display device.

### SUMMARY OF THE INVENTION

### Problems to be Solved by the Invention

Conventional techniques of increasing retention capacitance disadvantageously lead to low manufacturing yields.

### Solution to the Problems

The present disclosure, in one aspect thereof, is directed to a liquid crystal display device including: a liquid crystal layer; a pixel electrode and a common electrode both provided below the liquid crystal layer to form a liquid crystal capacitor; an organic layer formed in an underlying layer of the pixel electrode and the common electrode; a relay electrode formed in an underlying layer of the organic layer and connected electrically to the pixel electrode; and a capacitor electrode formed in an underlying layer of the organic layer to form a retention capacitor between the capacitor electrode and the relay electrode.

### Advantageous Effects of the Invention

The present disclosure can increase retention capacitance while ensuring sufficient yields in manufacturing liquid crystal display devices.

### BRIEF DESCRIPTION OF DRAWINGS

FIG. 1 is a plan view of an exemplary structure of a liquid crystal display device in accordance with the present embodiment.

FIG. 2 is a cross-sectional view of an exemplary structure of a display section and a non-display section, including the a-a cross-section shown in FIG. 1.

FIG. 3 is a circuit diagram of an exemplary structure of a subpixel in the present liquid crystal display device.

FIG. 4 is an enlarged plan view of a part of FIG. 1.

FIG. 5 is a plan view of an exemplary structure of a liquid crystal display device.

FIG. 6 is a cross-sectional view of an exemplary structure of a liquid crystal display device.

FIG. 7 is a cross-sectional view of an exemplary structure of a liquid crystal display device.

FIG. 8 is a plan view of an exemplary structure of a liquid crystal display device.

FIG. 9 is a plan view of an exemplary structure of a liquid crystal display device.

FIG. 10 is a plan view of an exemplary pattern of capacitor electrodes and relay electrodes.

FIG. 11 is a plan view of an exemplary pattern of capacitor electrodes and relay electrodes.

FIG. 12 is a plan view of an exemplary pattern of capacitor electrodes and relay electrodes.

FIG. 13 is a plan view of an exemplary pattern of capacitor electrodes and relay electrodes.

FIG. 14 is a plan view of an exemplary pattern of capacitor electrodes and relay electrodes.

### DESCRIPTION OF EMBODIMENTS

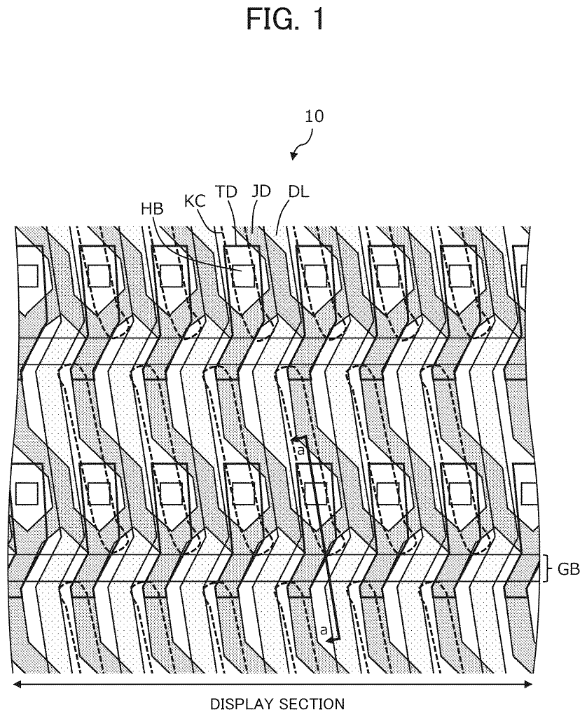

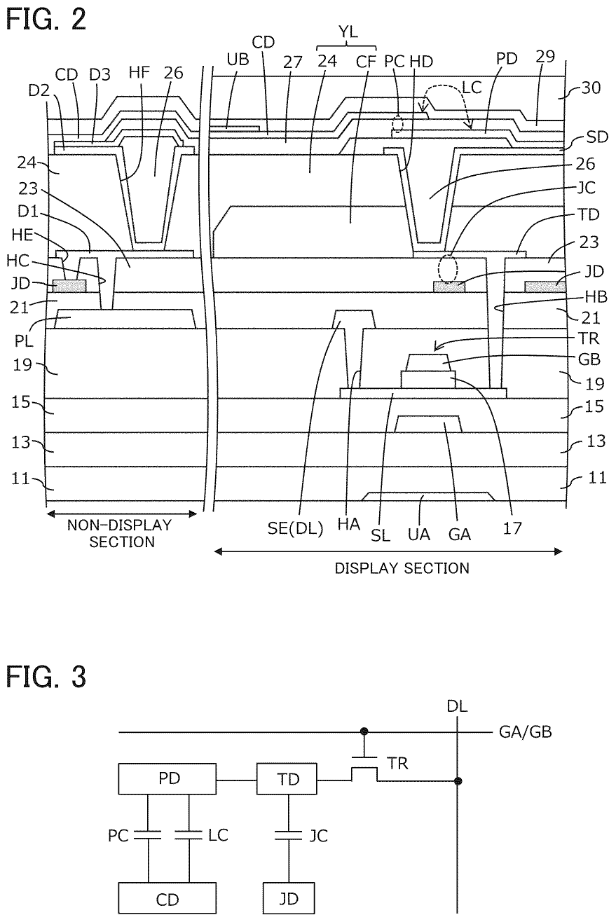

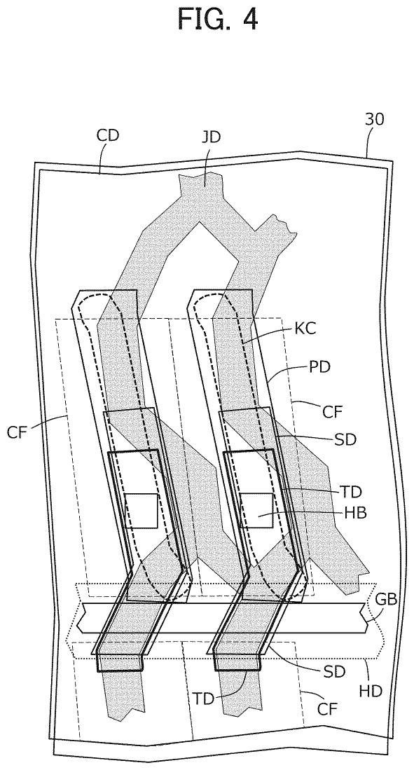

FIG. 1 is a plan view of an exemplary structure of a liquid crystal display device in accordance with the present embodiment. FIG. 2 is a cross-sectional view of an exemplary structure of a display section and a non-display section, including the a-a cross-section shown in FIG. 1. FIG. 3 is a circuit diagram of an exemplary structure of a subpixel in the present liquid crystal display device. FIG. 4 is an enlarged plan view of a part of FIG. 1. Referring to FIGS. 1 to 4, a liquid crystal display device 10 in accordance with the present embodiment includes: a liquid crystal layer 30; pixel electrodes PD and a common electrode CD both provided below the liquid crystal layer 30 to form liquid crystal capacitors LC; an organic layer YL formed in an underlying layer of the pixel electrodes PD and the common electrode CD; relay electrodes TD formed in an underlying layer of the organic layer YL to be electrically connected to the pixel electrodes PD; and capacitor electrodes JD formed in an underlying layer of the organic layer YL to form retention capacitors JC between the capacitor electrodes JD and the relay electrodes TD.

The addition of the retention capacitors JC (underlying retention capacitors) by forming the capacitor electrodes JD in an underlying layer of the organic layer YL as described here enables increasing the total retention capacitance while ensuring sufficient manufacturing yields. A retention capacitor PC (overlying retention capacitor) may be formed in a location where the pixel electrode PD and the common electrode CD overlap via an insulation film 27 (e.g., inorganic insulation film). Note that a “first structural member formed in an underlying layer of a second structural member” indicates that the first structural member is formed in a step that precedes the step of forming the second structural member.

The liquid crystal display device 10 has a display section DA including: a light-blocking layer UA; insulation films 11, 13 (e.g., inorganic insulation films); first scan lines GA; an insulation film 15 (e.g., inorganic insulation film); a semiconductor layer (e.g., oxide semiconductor layer) SL; an insulation film 17 (e.g., inorganic insulation film); second scan lines GB; an insulation film 19 (e.g., inorganic insulation film); source electrodes SE; an insulation film 21 (e.g., inorganic insulation film); the capacitor electrodes JD; an insulation film 23 (e.g., inorganic insulation film); the relay electrodes TD; the organic layer YL (including a color filter CF and an organic insulation film 24 on the color filter CF); auxiliary electrodes SD; an insulation film 26 (e.g., planarization film); the pixel electrodes PD; the insulation film 27 (e.g., inorganic insulation film); the common electrode CD; a light-blocking layer UB; and an insulation film 29 (e.g., inorganic insulation film), all of which are provided in this order. The liquid crystal layer 30 is provided on the insulation film 29 via an alignment film.

The first scan lines GA, the insulation film 15 (e.g., inorganic insulation film), the semiconductor layer SL, the insulation film 17, and the second scan lines GB form transistors TR. The semiconductor layer SL provides source regions each of which is connected to one of the source electrodes SE via a contact hole HA running through the insulation film 19, and the source electrodes SE are connected to data lines DL. The data line DL may include a portion that provides the source electrode SE. The semiconductor layer SL provides drain regions each of which is connected to one of the relay electrodes TD via a contact hole HB running through the insulation films 19, 21, and 23. The semiconductor layer SL may be an oxide semiconductor (e.g., indium gallium zinc oxide). The light-blocking layer UA may overlap photo-spacers (not shown) in the liquid crystal layer 30 in a plan view. The light-blocking layer UA may overlap the semiconductor layer SL (e.g., oxide semiconductor) in a plan view.

The relay electrode TD and the pixel electrode PD are electrically connected together by connecting the relay electrode TD to the auxiliary electrode SD via a contact hole HD that runs through the organic layer YL (the color filter CF and the organic insulation film 24) and bringing a part of the auxiliary electrode SD into contact with the pixel electrode PD. The transmittance of the liquid crystal layer 30 (vicinity of an opening KC) is controlled by the electric field (in-plane electric field) produced by the pixel electrode PD that reaches the common electrode CD via the opening KC in the common electrode CD and the liquid crystal layer 30.

The capacitor electrode JD, the relay electrode TD, and the common electrode CD may include an electrically conductive, transparent film (e.g., indium tin oxide or indium zinc oxide), which is merely illustrative. Alternatively, the capacitor electrode JD, the relay electrode TD, and the common electrode CD may include a transparent super-thin film (e.g., approximately 3.0 nm to 20 nm) of, for example, silver, aluminum, or a magnesium-silver alloy.

An electrode film sitting on an underlayer that has a high degree of surface roughness (e.g., organic layer) has thick resist in recesses and thin resist in the parts other than the recesses, which among other causes renders it difficult to perform high definition patterning. In the present embodiment, however, the capacitor electrode JD can be patterned in a precise and stable manner by providing the capacitor electrode JD on an underlying side of the organic layer YL which has a large thickness. In other words, the present embodiment is unlikely to develop defects such as leaks attributable to film residues in a capacitor electrode formation step and broken wiring attributable to a film cutoff in the capacitor electrode formation step. Hence, the present embodiment can increase charge retention capacitance while maintaining high yields, thereby improving display quality.

The capacitor electrode JD in accordance with the present embodiment is positioned in an overlying layer of the first and second scan lines GA and GB and the data line DL (source electrode SE) and in an underlying layer of the relay electrode TD. This structure lowers parasitic capacitance between the relay electrode TD and the data line DL and between the relay electrode TD and the scan lines GA and GB, which further improves display quality.

The insulation films 11, 13, 15, 17, 19, 21, 23, 27, and 29 may include an inorganic insulation film (e.g., a silicon oxide film or a silicon nitride film) with a thickness of approximately 0.05 μm to 0.5 μm. The color filter CF, the organic insulation film 24, and a planarization layer 26 may each have a thickness of approximately 1.0 μm to 3.0 μm. The organic layer YL may be thicker than each of the insulation films 11, 13, 15, 17, 19, 21, 23, 27, and 29. The organic insulation film 24 and the planarization layer 26 may be made of, for example, a polyimide.

Referring to FIGS. 1 to 4, the organic layer YL may include the color filter CF and may include the organic insulation film 24 formed in an overlying layer of the color filter CF. The common electrode CD and the capacitor electrode JD may be fed with a common potential Vcom. The common potential Vcom may be a DC voltage.

The liquid crystal display device 10 may include the data lines DL formed in an underlying layer of the capacitor electrodes JD, and the capacitor electrodes JD may include portions that overlap the data lines DL in a plan view. The capacitor electrode JD may be formed in an underlying layer of the relay electrode TD, and the insulation film 23 (e.g., inorganic insulation film) may be formed between the capacitor electrode JD and the relay electrode TD. The insulation film 23 has a thickness that may be less than or equal to ½ times, less than or equal to ⅓ times, or less than or equal to ⅕ times the thickness of the organic layer YL.

The liquid crystal display device 10 may include: the auxiliary electrodes SD formed in contact with the pixel electrodes PD in an overlying layer of the organic layer YL; and the contact holes HD that run through the organic layer YL to electrically connect the auxiliary electrodes SD and the relay electrodes TD. The common electrode CD may have the openings KC overlapping the pixel electrodes PD and the color filter CF in a plan view. The light-blocking layer UB, surrounding the openings KC in the common electrode in a plan view, may be formed on the common electrode CD. The light-blocking layer UB may be a color-mixture restraining layer.

The liquid crystal display device 10 may include a planarization film 26 that fills the contact holes HD, and the pixel electrodes PD may be extended onto the planarization film 26. The pixel electrodes PD and the common electrode CD may overlap in a plan view to form retention capacitors (overlying retention capacitors PC) between the pixel electrodes PD and the common electrode CD. The liquid crystal layer 30 may operate in in-plane electric field mode, and the common electrode CD may be formed in an overlying layer of the pixel electrodes PD.

The liquid crystal display device 10 may include the transistors TR provided in an underlying layer of the capacitor electrodes JD and connected to the relay electrodes TD. The first and second scan lines GA and GB may function as the gate electrode of the transistor TR, and the data line DL may be connected to the pixel electrode PD via the transistor TR, the relay electrode TD, and the contact hole HD.

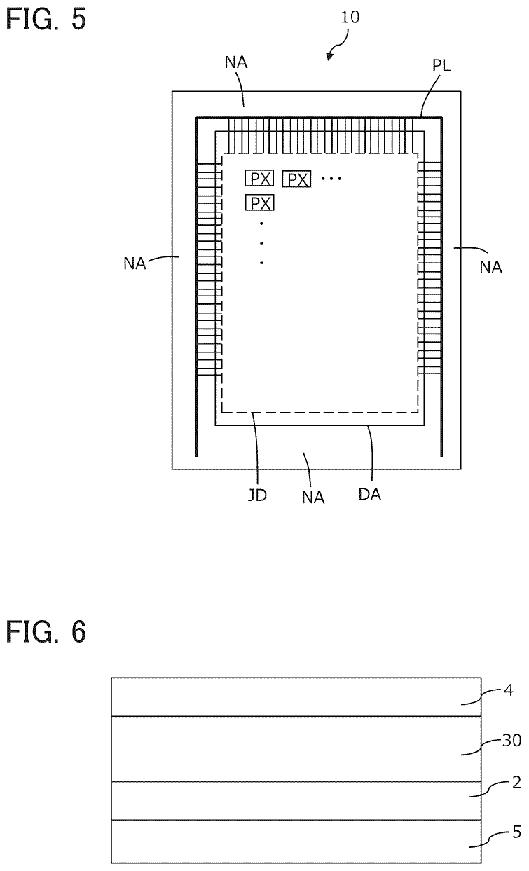

FIG. 5 is a plan view of an exemplary structure of a liquid crystal display device. Referring to FIGS. 2 and 5, the liquid crystal display device 10 has the display section DA and a non-display section NA, and the non-display section NA may include a power supply line PL to which the common potential Vcom is supplied. The capacitor electrodes JD may be provided in both the display section DA and the non-display section NA and may be connected electrically to the power supply line PL in the non-display section NA. The display section DA may include a plurality of pixels PX, and the display section DA may have a pixel density of greater than or equal to 1,000 ppi or greater than or equal to 1,500 ppi. The liquid crystal display device 10 may be a head-mounted display device (wearable display device) that has a pixel density of greater than or equal to 1,000 ppi.

The non-display section NA may include first electrodes D1 formed in the same layer as the relay electrodes TD, and the capacitor electrodes JD and the power supply line PL may be electrically connected together via the first electrodes D1. The power supply line PL may be formed in the same layer as the data lines DL (the source electrodes SE). The power supply line PL may be formed along an edge of the display section DA in a plan view.

The non-display section NA may include: second electrodes D2 formed in the same layer as the auxiliary electrodes SD; and third electrodes D3 formed in the same layer as the pixel electrodes PD, and the common electrode CD may be connected to the power supply line PL via the first to third electrodes D1 to D3.

In other words, the power supply line PL may be connected to the first electrodes D1 via contact holes HC that run through the insulation films 21 and 23, and the first electrodes D1 may be connected to the capacitor electrodes JD via contact holes HE that run through the insulation film 23 and connected also to the second electrodes D2 via contact holes HF that run through the organic insulation film 24. The second electrodes D2 and the third electrodes D3 may be in contact with each other, and the third electrodes D3 and the common electrode CD may be in contact with each other.

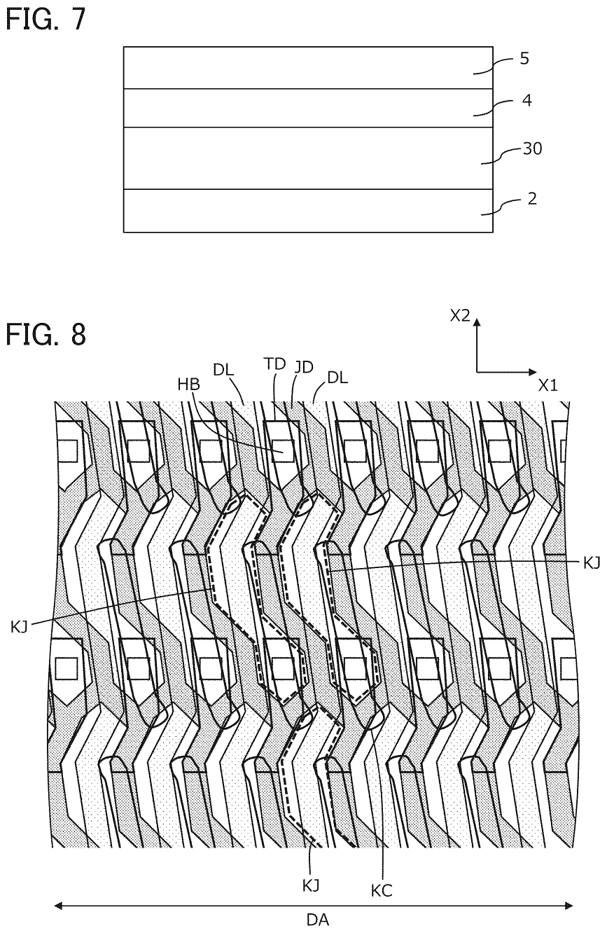

FIGS. 6 and 7 are cross-sectional views of an exemplary structure of a liquid crystal display device. Referring to FIGS. 2, 6, and 7, the liquid crystal display device 10 may include: a pixel circuit board 2 including the pixel electrodes PD, the common electrode CD, the organic layer YL, the relay electrodes TD, and the capacitor electrodes JD; an opposite substrate 4 positioned opposite the pixel circuit board 2 across the liquid crystal layer 30; and a light-emitting device 5 that projects light onto the liquid crystal layer 30 via the pixel circuit board 2 or the opposite substrate 4. The light-emitting device 5 may be provided on the same side as the pixel circuit board 2 as shown in FIG. 6 and may be provided on the same side as the opposite substrate 4 as shown in FIG. 7. The color filter CF may be formed on the pixel circuit board 2 (FIG. 2) and may be formed on the opposite substrate 4.

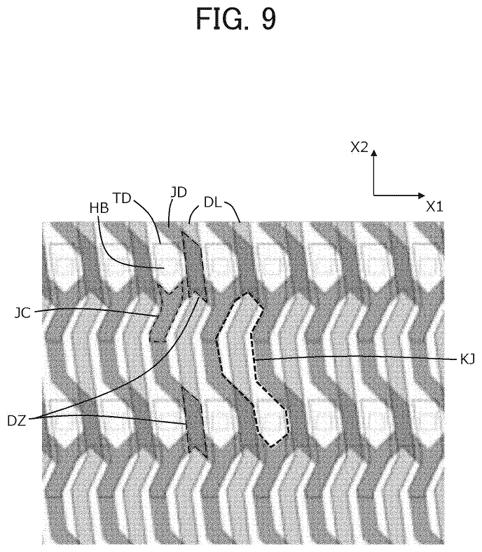

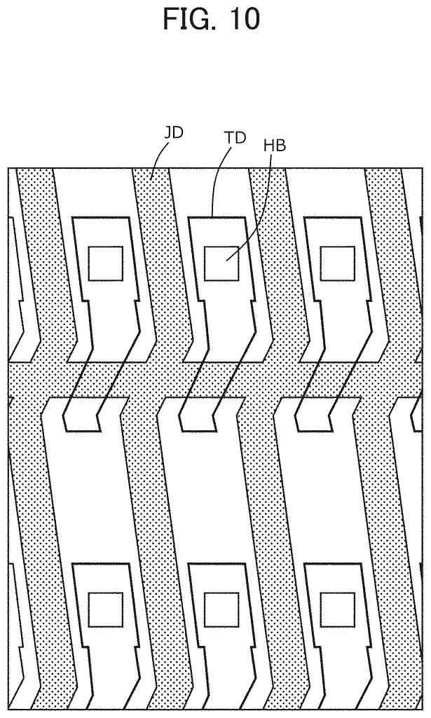

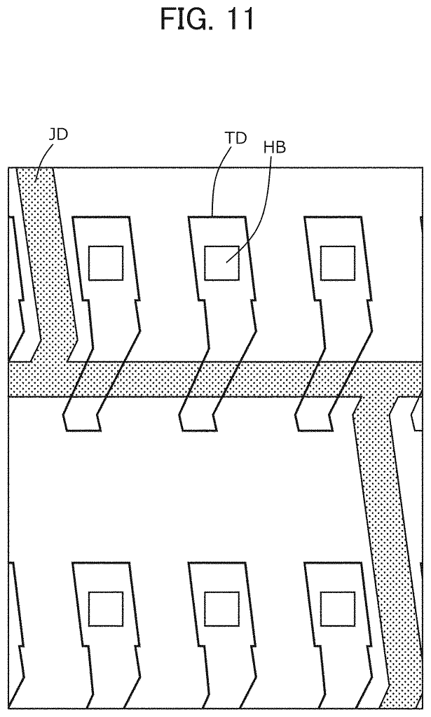

FIGS. 8 and 9 are plan views of an exemplary structure of a liquid crystal display device. Referring to FIGS. 8 and 9, the display section DA may include the plurality of data lines DL arranged side by side, and those data lines DL which are adjacent to each other may be fed with data signals of opposite polarities. The difference between a capacitor electrode overlapping ratio Ra (the ratio of the total area of a capacitor electrode overlapping portion DZ to the area of the top surface of the data line DL) of one of the adjacent data lines DL and a capacitor electrode overlapping ratio Rb of the other one of the adjacent data lines DL is preferably small and may satisfy an inequality of, for example, 0.9<Rb/Ra<1.1. A portion of the capacitor electrode JD may be aligned with a portion of the data line DL (see FIG. 9).

Referring to FIGS. 1, 8, and 9, the capacitor electrodes JD may form a mesh-like conductive pattern. The capacitor electrode JD may have a buckling opening KJ formed therein. The opening KJ in the capacitor electrode JD may be shaped so as to have a plurality of buckling sites (e.g., two sites). The capacitor electrodes JD, which form a conductive pattern, may have a plurality of openings KJ, and there may be a plurality of openings KJ formed in a staggering manner in a second direction X2 that is perpendicular to the arrangement direction of the data lines DL (a first direction X1: the lateral direction in the drawing). The opening KJ may be a polygon with no interior angles smaller than 80°. The opening KC in the common electrode CD may have an elongated shape extended obliquely to the second direction X2. In a plan view, the contact hole HB may overlap the opening KJ (opening in the capacitor electrode) and the opening KC (opening in the common electrode).

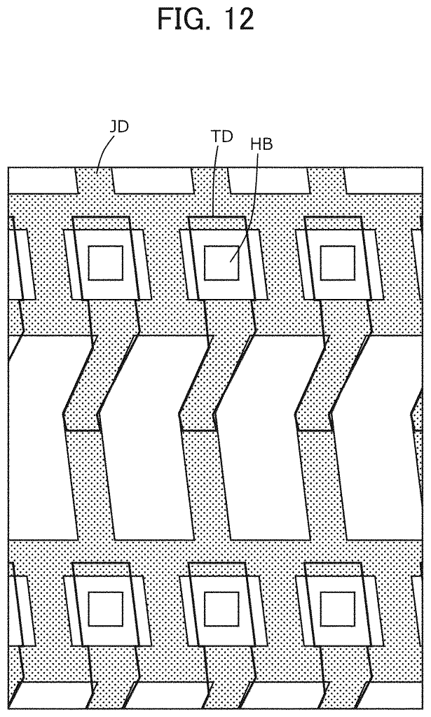

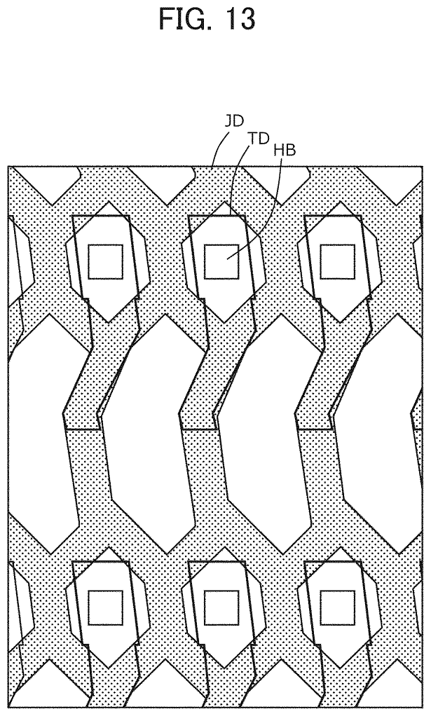

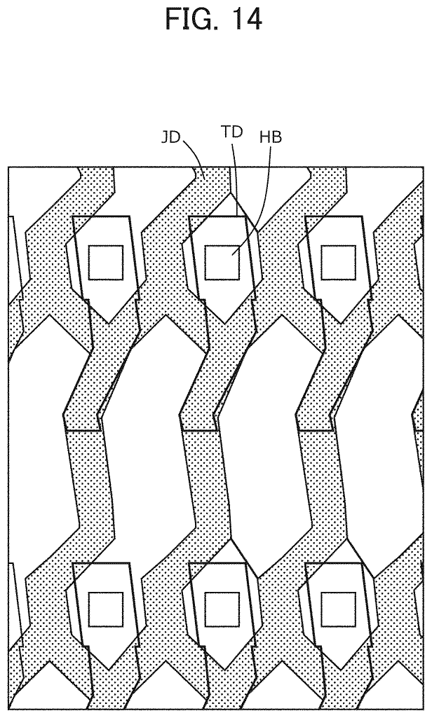

FIGS. 10 to 14 are plan views of an exemplary pattern of capacitor electrodes and relay electrodes. The pattern of the capacitor electrodes JD and the relay electrodes TD is by no means limited, for example, to the pattern shown in FIG. 1. Alternatively, the pattern may be any of the patterns shown in FIGS. 10 to 14. The capacitor electrode patterns shown in FIGS. 10 and 11 advantageously, for example, lower parasitic capacitance between the data and scan lines and the capacitor electrodes JD and allow for easy patterning. The capacitor electrode patterns shown in FIGS. 12 to 14 advantageously increase retention capacitance between the relay electrodes TD and the capacitor electrodes JD and also lower parasitic capacitance between the data lines DL and the capacitor electrodes JD while equalizing the capacitance loads of the data lines DL.

The embodiments and examples described so far are for illustrative purposes only and is by no means intended to limit the scope of the present disclosure. It is obvious to the person skilled in the art that many modifications and variations are possible based on the description. The following will summarize the gist of the present embodiment, where the “above-described” here encompasses the configurations disclosed in FIGS. 1 to 14.

### Summation

A liquid crystal display device including:
a liquid crystal layer;
a pixel electrode and a common electrode both provided below the liquid crystal layer to form a liquid crystal capacitor;
an organic layer formed in an underlying layer of the pixel electrode and the common electrode;
a relay electrode formed in an underlying layer of the organic layer and connected electrically to the pixel electrode; and
a capacitor electrode formed in an underlying layer of the organic layer to form a retention capacitor between the capacitor electrode and the relay electrode.

The above-described liquid crystal display device wherein the organic layer includes a color filter.

The above-described liquid crystal display device, wherein the organic layer includes an organic insulation film formed in an overlying layer of the color filter.

The above-described liquid crystal display device, wherein the common electrode and the capacitor electrode are fed with a common potential.

The above-described liquid crystal display device, wherein the capacitor electrode is formed in an underlying layer of the relay electrode.

The above-described liquid crystal display device, further including an inorganic insulation film formed between the capacitor electrode and the relay electrode.

The above-described liquid crystal display device, wherein the capacitor electrode is a mesh-like conductive pattern.

The above-described liquid crystal display device, wherein the capacitor electrode has a buckling opening.

The above-described liquid crystal display device, wherein the opening in the capacitor electrode has a plurality of buckling sites.

The above-described liquid crystal display device, wherein the common electrode and the capacitor electrode are transparent to light.

The above-described liquid crystal display device, further including a data line formed in an underlying layer of the capacitor electrode, wherein the capacitor electrode partly overlaps the data line in a plan view.

The above-described liquid crystal display device, further including:
an auxiliary electrode formed in an overlying layer of the organic layer and in contact with the pixel electrode; and
a contact hole running through the organic layer and connected electrically to the auxiliary electrode and the relay electrode.

The above-described liquid crystal display device, further including a display section and a non-display section, wherein
the non-display section includes a power supply line fed with a common potential, and
the capacitor electrode is formed in both the display section and the non-display section and connected electrically to the power supply line in the non-display section.

The above-described liquid crystal display device, wherein
the non-display section includes a first electrode formed in a same layer as the relay electrode, and
the capacitor electrode and the power supply line are electrically connected to each other via the first electrode.

The above-described liquid crystal display device, wherein
the non-display section includes: a second electrode formed in a same layer as the auxiliary electrode; and a third electrode formed in a same layer as the pixel electrode, and
the common electrode is connected to the power supply line via the first to third electrodes.

The above-described liquid crystal display device, wherein the common electrode has an opening overlapping the pixel electrode and the color filter in a plan view.

The above-described liquid crystal display device, further including a light-blocking layer formed on the common electrode and surrounding the opening in the common electrode in a plan view.

The above-described liquid crystal display device, further including a planarization film filling the contact hole, wherein the pixel electrode is extended onto the planarization film.

The above-described liquid crystal display device, wherein the pixel electrode and the common electrode overlap in a plan view to form a retention capacitor between the pixel electrode and the common electrode.

The above-described liquid crystal display device, wherein
the liquid crystal layer operates in in-plane electric field mode, and
the common electrode is formed in an overlying layer of the pixel electrode.

The above-described liquid crystal display device, further including a transistor formed in an underlying layer of the capacitor electrode and connected to the relay electrode.

The above-described liquid crystal display device, further including:
a pixel circuit board including the pixel electrode, the common electrode, the organic layer, the relay electrode, and the capacitor electrode;
an opposite substrate provided opposite the pixel circuit board via the liquid crystal layer; and
a light-emitting device that projects light onto the liquid crystal layer via the pixel circuit board or the opposite substrate.

The above-described liquid crystal display device, having a pixel density of greater than or equal to 1,000 ppi.

A pixel circuit board for a liquid crystal display device, including:
a pixel electrode and a common electrode capable of forming a liquid crystal capacitor;
an organic layer formed in an underlying layer of the pixel electrode and the common electrode;
a relay electrode formed in an underlying layer of the organic layer and connected electrically to the pixel electrode; and
a capacitor electrode formed in an underlying layer of the organic layer to form a retention capacitor between the capacitor electrode and the relay electrode.

What is claimed is:

1. A liquid crystal display device comprising:
a liquid crystal layer;
a pixel electrode and a common electrode both provided below the liquid crystal layer to form a liquid crystal capacitor;
an organic layer formed in an underlying layer of the pixel electrode and the common electrode;
a relay electrode formed in an underlying layer of the organic layer and connected electrically to the pixel electrode; and
a capacitor electrode formed in an underlying layer of the organic layer to form a retention capacitor between the capacitor electrode and the relay electrode.

2. The liquid crystal display device according to claim 1, wherein the organic layer includes a color filter.

3. The liquid crystal display device according to claim 2, wherein the organic layer includes an organic insulation film formed in an overlying layer of the color filter.

4. The liquid crystal display device according to claim 1, wherein the common electrode and the capacitor electrode are fed with a common potential.

5. The liquid crystal display device according to claim 1, wherein the capacitor electrode is formed in an underlying layer of the relay electrode.

6. The liquid crystal display device according to claim 1, further comprising an inorganic insulation film formed between the capacitor electrode and the relay electrode.

7. The liquid crystal display device according to claim 1, wherein the capacitor electrode is a mesh-like conductive pattern.

8. The liquid crystal display device according to claim 1, wherein the capacitor electrode has a buckling opening.

9. The liquid crystal display device according to claim 8, wherein the opening in the capacitor electrode has a plurality of buckling sites.

10. The liquid crystal display device according to claim 1, wherein the common electrode and the capacitor electrode are transparent to light.

11. The liquid crystal display device according to claim 1, further comprising a data line formed in an underlying layer of the capacitor electrode, wherein the capacitor electrode partly overlaps the data line in a plan view.

12. The liquid crystal display device according to claim 1, further comprising:
an auxiliary electrode formed in an overlying layer of the organic layer and in contact with the pixel electrode; and
a contact hole running through the organic layer and connected electrically to the auxiliary electrode and the relay electrode.

13. The liquid crystal display device according to claim 12, further comprising a display section and a non-display section, wherein
the non-display section includes a power supply line fed with a common potential, and
the capacitor electrode is formed in both the display section and the non-display section and connected electrically to the power supply line in the non-display section.

14. The liquid crystal display device according to claim 13, wherein
the non-display section includes a first electrode formed in a same layer as the relay electrode, and
the capacitor electrode and the power supply line are electrically connected to each other via the first electrode.

15. The liquid crystal display device according to claim 14, wherein
the non-display section includes: a second electrode formed in a same layer as the auxiliary electrode; and a third electrode formed in a same layer as the pixel electrode, and
the common electrode is connected to the power supply line via the first to third electrodes.

16. The liquid crystal display device according to claim 2, wherein the common electrode has an opening overlapping the pixel electrode and the color filter in a plan view.

17. The liquid crystal display device according to claim 16, further comprising a light-blocking layer formed on the common electrode and surrounding the opening in the common electrode in a plan view.

18. The liquid crystal display device according to claim 12, further comprising a planarization film filling the contact hole, wherein the pixel electrode is extended onto the planarization film.

19. The liquid crystal display device according to claim 1, wherein the pixel electrode and the common electrode overlap in a plan view to form a retention capacitor between the pixel electrode and the common electrode.

20. The liquid crystal display device according to claim 1, wherein
the liquid crystal layer operates in in-plane electric field mode, and
the common electrode is formed in an overlying layer of the pixel electrode.

21. The liquid crystal display device according to claim 1, further comprising a transistor formed in an underlying layer of the capacitor electrode and connected to the relay electrode.

22. The liquid crystal display device according to claim 1, further comprising:
a pixel circuit board including the pixel electrode, the common electrode, the organic layer, the relay electrode, and the capacitor electrode;
an opposite substrate provided opposite the pixel circuit board via the liquid crystal layer; and
a light-emitting device that projects light onto the liquid crystal layer via the pixel circuit board or the opposite substrate.

23. The liquid crystal display device according claim 1, having a pixel density of greater than or equal to 1,000 ppi.
